(19) United States
(12) Patent Application Publication
(10) Pub. No.: US 2010/0209736 A1
(43) Pub. Date: Aug. 19, 2010

(54) PERPENDICULAR MAGNETIC RECORDING MEDIUM AND MAGNETIC RECORDING AND REPRODUCING DEVICE

(75) Inventor: Atsushi Hashimoto, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku TOkyo (JP)

(21) Appl. No.: 12/676,590

(22) PCT Filed: Sep. 4, 2008
(86) PCT No.: PCT/JP2008/066007

§ 371 Date: Mar. 4, 2010

(30) Foreign Application Priority Data
Sep. 6, 2007 (JP) 2007 231841

(51) Int. Cl. G11B 5/33; G11B 5/66

(52) U.S. Cl. 428/815; 428/827; 428/828

(57) ABSTRACT

One object of the present invention is to provide a method for easily providing an ECC type magnetic recording medium with low cost, which is easily designed, and the present invention provides a perpendicular magnetic recording medium including at least a soft magnetic backing layer, an under layer, an intermediate layer, and a perpendicular magnetic recording layer on a non-magnetic substrate, wherein the perpendicular magnetic recording layer includes at least one of a main recording layer and an auxiliary recording layer, the main recording layer includes a layer having perpendicular magnetic anisotropy, the auxiliary recording layer is a multilayer including three or more of a soft magnetic layer and a non-magnetic layer which are layered alternately, and the outermost layer to the non-magnetic substrate is the soft magnetic layer.

### TECHNICAL FIELD

The present invention relates to a perpendicular magnetic recording medium and a magnetic recording and reproducing device using the perpendicular magnetic recording medium.

Priority is claimed on Japanese Patent Application, No. 2007-231841, filed on Sep. 6, 2007, the contents of which are incorporated herein by reference in their entirety.

### BACKGROUND ART

In recent years, the applicable scope of magnetic recording devices, such as magnetic disk devices, flexible disk devices, and magnetic tape devices, has remarkably increased. As the importance of such magnetic recording device increases, the recording density of magnetic recording media used in such magnetic recording devices has dramatically improved. In particular, with the introduction of MR heads and PRML, the surface recording density has further increased. In recent years, GMR heads, and TuMR heads, etc. have been further introduced. Due to this, the surface recording density has continuously increased at the rate of 100% a year.

Thus, it is required that the magnetic recording media have a higher recording density. In order to achieve this, a high coercive force, high signal-to-noise ratio (S/N ratio), and high resolution are required in the magnetic recording layer. In order to achieve this, it is necessary to promote the minuteness and magnetic isolation of magnetic crystal grains in a recording layer which holds information.

However, when the grain diameter is decreased by an in-plane magnetic recording method of the conventional technology, potential energy of magnetization inversion, which is the product of a magnetization inversion volume and a crystal magnetic anisotropy energy (Kᵤ), is also decreased. As a result, there is a problem in that the magnetization inversion easily occurs by thermal relaxation.

From such problems in the background, a perpendicular magnetic recording method is expected as a leading technique which can achieve further higher recording density. Dissimilar to the in-plane magnetic recording method, this method has a characteristic in that the axis of easy magnetization of magnetic crystal grains is a perpendicular direction relative to the surface of the medium. Here, “axis of easy magnetization” means an axis to which magnetization easily aligns. In the case of Co-based alloys, the axis of easy magnetization is an axis (c axis) which is parallel to the normal line of the (0001) plane of the hcp structure of Co. For this reason, in principle, the effects of the demagnetizing field between recording bits are small in high recording density states, and it makes static magnetism conditions stable.

The perpendicular magnetic recording medium commonly has an under layer, an intermediate layer, a magnetic recording layer, and a protective layer, which are layered on a non-magnetic substrate, in this order. A lubricant layer is often layered on the protective layer. In addition, a magnetic film, which is called a “soft magnetic backing layer”, is often formed under the under layer. The under layer and the intermediate layer are formed to improve properties of the magnetic recording layer. Specifically, these layers control the diameter of the magnetic crystal grains and magnetic isolation properties while orientating the crystals in the magnetic recording layer.

In order to produce high density-perpendicular magnetic recording media having excellent properties, it is necessary to decrease noise while maintaining thermal stability. In order to decrease noise, a method is commonly used in which magnetic crystal grains in a recording layer are magnetically isolated in the plane of the recording layer, and magnetic interaction between the magnetic crystal grains is decreased while the magnetic crystal grains are miniaturized.

However, when noise is decreased by this method, it is consequently necessary to decrease Ku of the magnetic crystal grains in order to maintain thermal stability. When the magnetic anisotropic energy of the magnetic crystal grains is increased, an anisotropic magnetic field, saturation field, and coercive force are also increased. Thereby, the recording field, which is required for the magnetization inversion in writing, is also increased. Due to this, writability, when a recording head is used, is deteriorated, and recording and reproducing properties are also decreased.

In order to solve the problems, so called ECC (Exchange Coupled Composite) media have been suggested, in which a layer (auxiliary recording layer) which contains soft magnetic grains isolated magnetically is formed on or under a perpendicular magnetic recording layer (main recording layer) which contains ferromagnetic grains isolated magnetically and which have a granular structure (For example, Non-Patent Document No. 1). The greatest characteristic of the ECC media is that the magnetization direction of the entire perpendicular magnetic recording layer containing both ferromagnetic grains and soft magnetic grains is the perpendicular direction while having residual magnetization, however, when the magnetization direction is inverted, magnetic moments do not invert all at once, and the magnetic moments are twisted in the thickness direction of the layer and inverted incoherently.

Specifically, the magnetic moments face toward the perpendicular direction in the states not applied with recording field. While being applied with a recording field, magnetic moments in the auxiliary recording layer start to magnetically rotate earlier than the magnetic moments in the main recording layer in the ECC media, dissimilar to conventional perpendicular magnetic recording media. Thereby, during magnetization inversion, ferromagnetic grains in the main recording layer are assisted by exchange of magnetic field between soft magnetic grains in the auxiliary recording layer, in addition to the applied magnetic field and demagnetizing field of itself. Therefore, magnetization inversion easily occurs in low magnetic fields, and writability is remarkably improved, compared with conventional perpendicular magnetic recording media.

Non-Patent Documents Nos. 2 and 3 disclose that indirect exchange coupling energy works between ferromagnetic layers by inserting an extremely thin non-magnetic layer between the ferromagnetic layers.

### [Non-Patent Document No. 1] IEEE Transactions on Magnetics, vol. 41, pp. 537

[Non-Patent Document No. 2] S. S. P. Parkin, Phys. Rev. Lett., 67, 3598 (1991).
[Non-Patent Document No. 3] P. Bruno and C. Chappert, Phys. Rev. Lett., 67, 1602 (1991).

### DISCLOSURE OF THE INVENTION

### Problems to be Solved by the Invention

As explained above, in order to exert the characteristic of the ECC media, it is necessary to control the magnetization inversion mode, that is, to control the exchange coupling between the auxiliary recording layer and the perpendicular magnetic recording layer, and the exchange coupling in the auxiliary recording layer. Among these, the exchange coupling between the auxiliary recording layer and the perpendicular magnetic recording layer can be controlled by inserting a magnetic layer or a non-magnetic layer between these layers and adjusting the thickness of the inserted layer. However, it is difficult to control the exchange coupling in the auxiliary recording layer when the auxiliary recording layer is made of only a soft magnetic material, because the exchange coupling is determined only by the kind of soft magnetic materials used.

According to Non-Patent Documents Nos. 2 and 3, indirect exchange coupling energy works between ferromagnetic layers by inserting an extremely thin non-magnetic layer between the ferromagnetic layers. This phenomenon is called a RKKY interaction and the indirect exchange coupling in the RKKY interaction is called RKKY interlayer coupling.

As shown in FIG. 2, the RKKY interlayer coupling varies from positive to negative by increasing the thickness of the non-magnetic layer (Spacer Layer). In other words, the RKKY interlayer coupling changes in a vibrating manner from ferromagnetic coupling to anti-ferromagnetic coupling. Here, “ferromagnetic coupling” means energy for aligning the magnetic moments in the ferromagnetic layer parallel, and “anti-ferromagnetic coupling” means energy for aligning the magnetic moments in the ferromagnetic layer non-parallel.

As shown in FIG. 3, the RKKY interlayer coupling is different depending on the kind of non-magnetic material constituting the inserted layer. FIG. 3 shows a coupling constant (J1) when a non-magnetic layer is inserted between ferromagnetic layers containing Co and a transition metal. In particular, it is clear that the RKKY interlayer coupling constant of Ru, Ir, and Rh is large.

From these facts, it can be understood that when the RKKY interaction coupling is used and the kind and the thickness of the non-magnetic layer varies, exchange coupling between ferromagnetic layers can be easily controlled. That is, it can be considered that the exchange coupling in the auxiliary recording layer can be controlled by using a multilayer film having the soft magnetism layer and the extremely thin non-magnetic layer as the auxiliary layer.

The present invention is achieved by the above-mentioned considerations, and the object of the present invention is to provide a perpendicular magnetic recording medium which has both excellent thermal stability of recording magnetization and writability, and can record and reproduce high density information by forming the auxiliary recording layer capable of controlling the exchange coupling, and a magnetic recording and reproducing device.

### Means for Solving the Problem

In order to achieve the object, the present invention provides the following perpendicular magnetic recording medium and magnetic recording and reproducing device.

(1) A perpendicular magnetic recording medium including at least a soft magnetic backing layer, an under layer, an intermediate layer, and a perpendicular magnetic recording layer, which are disposed on a non-magnetic substrate, wherein the perpendicular magnetic recording layer includes at least one of a main recording layer and at least one of an auxiliary recording layer, the main recording layer includes a layer having perpendicular magnetic anisotropy, the auxiliary recording layer is a multilayer including three or more of a soft magnetic layer and a non-magnetic layer which are layered alternately, and the outermost layer to the non-magnetic substrate is the soft magnetic layer.
(2) A perpendicular magnetic recording medium according to (1), wherein the thickness of each non-magnetic layer constituting the auxiliary layer is in a range of from 0.2 nm to 3 nm.
(3) A perpendicular magnetic recording medium according to (1) or (2), wherein the non-magnetic layer constituting the auxiliary layer contains at least one metal or an alloy of Ru, Ir, Rh, Re, Cr, Cu, Ta, and W.
(4) A perpendicular magnetic recording medium according to any one of (1) to (3), wherein the thickness of the soft magnetic layer constituting the auxiliary layer is 4 nm or less, and the total thickness of the soft magnetic layer constituting the auxiliary recording layer is half or less the total thickness of the main recording layer.
(5) A perpendicular magnetic recording medium according to any one of (1) to (4), wherein the non-magnetic layer and the soft magnetic layer, which constitute the auxiliary recording layer, have a granular structure in which a metal crystal grain part is surrounded by a non-magnetic oxide grain boundary, and the oxide contains at least one of Si, Ti, Ta, Cr, Al, W, Nb, Mg, Ru, and Y.
(6) A perpendicular magnetic recording medium according to any one of (1) to (5), wherein the total amount of the oxide contained in the auxiliary recording layer is in a range of from 2% by mol to 20% by mol.
(7) A perpendicular magnetic recording medium according to any one of (1) to (6), wherein at least one layer of the main recording layer has a granular structure in which a magnetic crystal grain part is surrounded by a non-magnetic oxide grain boundary, and the oxide contained in the main recording layer contains at least one of Si, Ti, Ta, Cr, Al, W, Nb, Mg, Ru, and Y.
(8) A perpendicular magnetic recording medium according to any one of (1) to (7), wherein the total amount of the oxide contained in the main recording layer is in a range of from 2% by mol to 20% by mol.
(9) A perpendicular magnetic recording medium according to any one of (1) to (8), wherein the average diameter of the magnetic crystal grains in the main recording layer is in a range of from 3 nm to 12 nm.
(10) A perpendicular magnetic recording medium according to any one of (1) to (9), wherein the thickness of the main recording layer is in a range of from 1 nm to 20 nm, and the total thickness of the perpendicular magnetic recording layer including the main recording layer is in a range of from 2 nm to 40 nm.
(11) A perpendicular magnetic recording medium according to any one of (1) to (10), wherein the soft magnetic backing layer has a soft magnetic non-crystalline structure or a soft magnetic fine crystalline structure.
(12) A perpendicular magnetic recording and reproducing device having a perpendicular magnetic recording medium and a magnetic head for recording and reproducing information of a perpendicular magnetic recording medium, wherein the perpendicular magnetic recording medium is the perpendicular magnetic recording medium according to any one of (1) to (11).

### EFFECTS OF THE PRESENT INVENTION

According to the present invention, it is possible to provide a perpendicular magnetic recording medium which has excellent recording and reproducing properties while maintaining high thermal stability of the perpendicular magnetic recording layer, and high recording density.

### BRIEF DESCRIPTION OF THE DRAWINGS

FIG. 1 shows a cross-sectional view of the perpendicular magnetic recording medium according to the present invention.

FIG. 2 shows the relationship between a saturation field, which is an index of the RKKY interlayer coupling disclosed in Non-Patent Document No. 2, and the thickness of the non-magnetic layer.

FIG. 3 shows the RKKY interlayer coupling constant J₁ when various non-magnetic layers shown in Non-Patent Document No. 2 are used.

FIG. 4 shows the structure of the magnetic recording and reproducing device according to the present invention.

FIG. 5 shows the relationship between the total thickness of the soft magnetic layer and SNR when one soft magnetic layer constituting the auxiliary recording layer is varied in the perpendicular magnetic recording medium according to the present invention.

FIG. 6 shows the relationship between the total thickness of the soft magnetic layer and resistance to thermal fluctuation when one soft magnetic layer constituting the auxiliary recording layer is varied in the perpendicular magnetic recording medium according to the present invention.

FIG. 7 shows the relationship between the total thickness of the soft magnetic layer and SNR when the number of layerings of the soft magnetic layer constituting the auxiliary recording layer are varied in the perpendicular magnetic recording medium according to the present invention.

FIG. 8 shows the relationship between the total thickness of the soft magnetic layer and resistance to thermal fluctuation when the number of layerings of the soft magnetic layer constituting the auxiliary recording layer are varied in the perpendicular magnetic recording medium according to the present invention.

FIG. 9 shows the relationship between the thickness of one non-magnetic layer constituting the auxiliary recording layer and SNR in the perpendicular magnetic recording medium according to the present invention.

FIG. 10 shows the relationship between the thickness of one non-magnetic layer constituting the auxiliary recording layer and resistance to thermal fluctuation in the perpendicular magnetic recording medium according to the present invention.

FIG. 11 shows the relationship between the amount of the oxide in the auxiliary recording layer and SNR in the perpendicular magnetic recording medium according to the present invention.

FIG. 12 shows the relationship between the amount of the oxide in the main recording layer and SNR in the perpendicular magnetic recording medium according to the present invention.

### EXPLANATION OF REFERENCE SYMBOLS

1 non-magnetic substrate
2 soft magnetic backing layer
3 under layer
4 intermediate layer
5 perpendicular magnetic recording layer
6 protective layer
100 perpendicular magnetic recording medium
101 medium driving portion
102 magnetic head
103 head driving portion
104 recording and reproduction signal system

### BEST MODE FOR CARRYING OUT THE INVENTION

Below, the present invention is explained in detail.

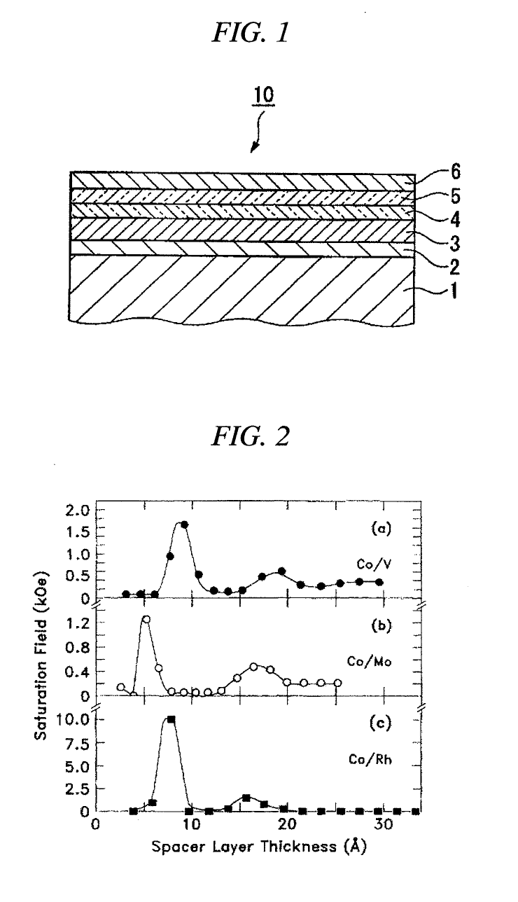

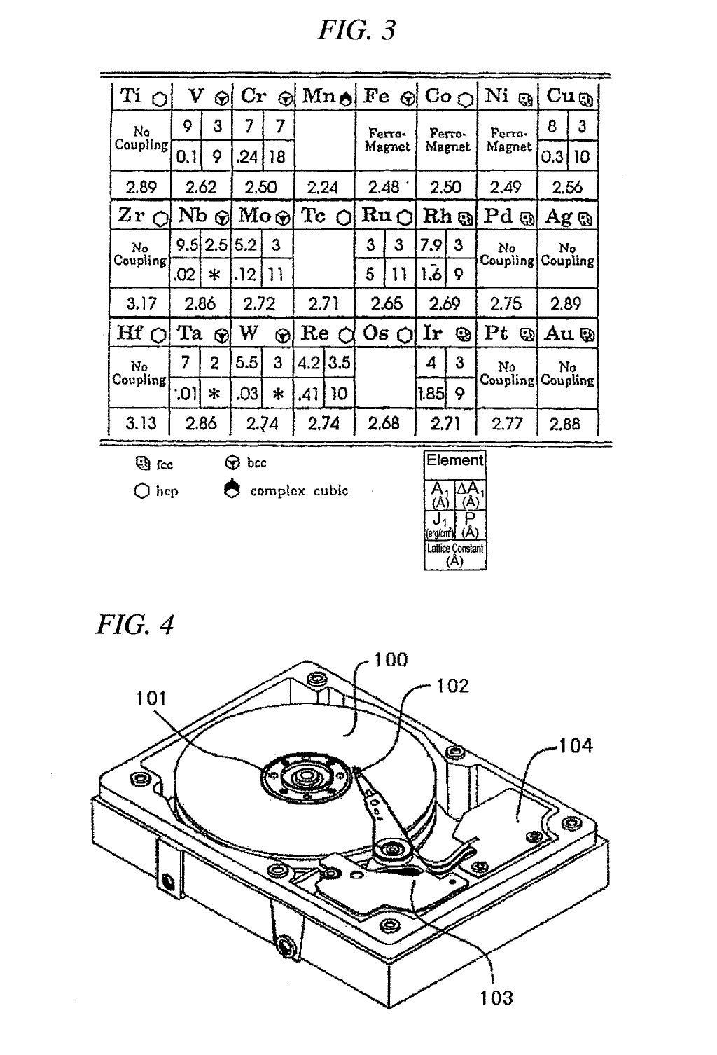

FIG. 1 shows a cross-sectional view of one example of the perpendicular magnetic recording medium according to the present invention. As shown in FIG. 1, the perpendicular magnetic recording medium 10 is a perpendicular medium which has a soft magnetic backing layer 2, an under layer 3 and an intermediate layer 4 which constitute a orientation control layer for controlling the orientation of a film disposed thereonto, a perpendicular magnetic recording layer (this may be abbreviated as “magnetic recording layer”) 5, and a protective layer 6, on a non-magnetic substrate 1. The perpendicular magnetic recording layer 5 has a main recording layer in which the axis of easy magnetization (c-axis) is orientated perpendicularly to the non-magnetic substrate 1, and an auxiliary recording layer having soft magnetic properties. The layering order may be the intermediate layer 4—the auxiliary recording layer—the main recording layer; or the intermediate layer 4—the main recording layer—the auxiliary recording layer.

Below, each layer in the perpendicular magnetic recording will be explained.

First, the non-magnetic substrate 1 is explained.

Examples of the non-magnetic substrate 1 used in the perpendicular magnetic recording medium of the present invention include any non-magnetic substrates, such as a substrate made of an aluminum alloy, such as an Al—Mg alloy containing Al as a main component, a substrate made of common glass, aluminosilicate-based glass, amorphous glass, silicon, titanium, ceramics, sapphire, or quartz, and a substrate made of resin. Among these, an Al alloy substrate, a crystallized glass substrate, and an amorphous glass substrate are often used. When a glass substrate is used, a substrate having an Ra less than 1 Å, such as a mirror-polished glass substrate, is preferably used. When the content is low, texture may be added in the glass substrate.

In general, at first, the substrate is cleaned and dried in the production steps of magnetic discs. In the present invention, it is preferable that the substrate be cleaned and dried before layering the layers, from the viewpoint of adhesion of layers. The cleaning in the present invention includes not only an aqueous cleaning but also etching (reverse-sputtering). In addition, the size of the substrate is not particularly limited.

Next, the soft magnetic backing layer (this may be abbreviated as “backing layer”) 2 is explained.

The backing layer 2 introduces a recording field from the magnetic head and applies effectively the perpendicular component of the recording field to the magnetic recording layer 5, during the recording of signals in the perpendicular magnetic recording medium.

Examples of the material constituting the backing layer 2 include materials having so-called soft magnetic properties, such as a FeCo-based alloy, a CoZrNb-based alloy, and a CoTaZr-based alloy. When the surface roughness (Ra) of the soft magnetic backing layer 2 is small, the floating height of the magnetic head can be decreased, and this allows further higher recording density. Therefore, it is preferable that the material constituting the soft magnetic backing layer 2 be made of an amorphous material or a material containing fine crystals.

A backing layer having an AFC, in which a non-magnetic thin film made of Ru, etc. is inserted into two soft magnetic layers, can also be used as the backing layer in the present invention.

The total thickness of the backing layer 2 is in a range of from 20 nm to 120 nm, and depends on the balance between the recording and reproducing properties and OW properties.

When the soft magnetic backing layer 2 contains fine crystals or has an amorphous structure, there is a case in which Ra remarkably increases depending on the material used or film forming conditions.

In this case, it is possible to decrease Ra and improve crystalline properties of the magnetic recording layer 5 by forming a non-magnetic amorphous layer between the backing layer 2 and the under layer 3.

Next, the under layer 3 and the intermediate layer 4, which are formed on the backing layer 2, are explained.

In the present invention, an orientation control layer, which controls the orientation of the magnetic recording layer 5, is formed on the backing layer 2. The orientation control layer has plural layers. The plural layers are the under layer 3 and the intermediate layer 4 from the substrate side.

Examples of the material for the under layer 3 include Ta, and metals or alloys having an fcc structure having (111) plane orientation, such as Ni, Ni—Nb, Ni—Ta, Ni—V, Ni—W, and Pt.

In general, examples of the material constituting the intermediate layer 4 include Ru, Re, and alloys thereof, which have an hcp structure, similar to the magnetic recording layer 5. The intermediate layer 4 is formed in order to control the orientation of the magnetic recording layer 5. Therefore, any materials can be used as long as they can control the orientation of the magnetic recording layer 5 when it does not have an hcp structure.

In the present invention, when the main recording layer, which constitutes the perpendicular magnetic recording layer 5, has a granular structure, it is preferable that the intermediate layer 4 have an uneven surface obtained by increasing gas pressure in making the intermediate layer 4. However, there is a case in which the crystalline orientation of the intermediate layer 4 is deteriorated by increasing the gas pressure, and the surface roughness becomes too large. This problem can be solved by balancing the orientation and unevenness at the surface by optimizing the gas pressure in making the intermediate layer 4 or separating the intermediate layer 4 into a layer formed with low gas pressures, and another layer formed with high gas pressures.

Next, the perpendicular magnetic recording layer 5 is explained. The perpendicular magnetic recording layer 5 includes the main recording layer and the auxiliary recording layer.

In layers forming the perpendicular magnetic recording layer 5, the main recording layer is a layer in which signals are actually recorded, in the literature.

In the present invention, the main recording layer may be a single layer or a multiple layer having two layers or more. It is preferable that at least one layer constituting the main recording layer have a granular structure containing an oxide and ferromagnetic crystal grains of an alloy containing Co as a main component.

Examples of the ferromagnetic crystal grains which are preferably contained in the magnetic recording layer 5 include CoCr, CoCrPt, CoPt, CoCrB, CoPtB, CoCrPtRu, CoCrRu, CoCrPtRuB, CoPtRu, CoPtRuB, and CoCrRuB.

As the oxide which is preferably contained in the magnetic recording layer 5, an oxide containing at least one of Si, Ti, Ta, Cr, Al, W, Nb, Mg, Ru, and Y can be used.

It is preferable that the thickness of the main recording layer be in a range of from 1 nm to 20 nm. The average grain diameter of the ferromagnetic crystal is preferably in a range of from 3 nm to 12 nm. The average grain diameter can be measured using planar TEM images.

As explained above, the main recording layer may be a single layer. However, it is possible that a second magnetic recording layer be formed on or under the first magnetic recording layer, which is explained in “magnetic recording layer” above, and thereby the magnetic recording layer can be a multiple layer.

A ferromagnetic material and an oxide of the second magnetic recording layer can be selected from the ferromagnetic materials and the oxides used in the first magnetic recording layer. Moreover, the second magnetic recording layer may not contain an oxide.

When the main recording layer is a multiple layer, the total thickness thereof is preferably in a range of from 2 nm to 40 nm.

The main magnetic recording layer in the present invention can be formed by sputtering using a material constituting each layer as a target.

As a ferromagnetic alloy material used as a target for the main recording layer, it is preferable that it essentially contain Co, and more preferably contains Cr in addition to Co. Examples of the ferromagnetic alloy include Co-based alloys, such as CoCr, CoCrPt, CoCrPtRu, CoCrPtB, CoCrPtRuB, CoCrPtB-X, CoCrPtRuB-X, CoCrPtB-X-Y, and CoCrPtRuB-X-Y. Moreover, X and Y denote the oxide which is explained above.

Among layers constituting the perpendicular magnetic recording layer 5 in the present invention, the auxiliary recording layer is a layer which assists the magnetization inversion in the main recording layer while the perpendicular magnetic recording layer 5 is applied with a recording field.

In the present invention, the auxiliary recording layer is a multiple layer including three or more layers in which a non-magnetic layer containing an oxide grain boundary, and a soft magnetic layer containing an oxide grain boundary are alternately layered.

It is preferable that the non-magnetic layer and the soft magnetic layer, which form the auxiliary recording layer, have a granular structure containing crystal grain boundaries of metal crystal grains and non-magnetic oxide.

Examples of the non-magnetic oxide include Si, Ti, Ta, Cr, Al, W, Nb, Mg, Ru, and Y. These oxides can be used alone or in combination.

A layer for controlling the exchange coupling depending on situations can be formed between the main recording layer and the auxiliary recording layer. The exchange coupling-controlling layer may be made of a non-magnetic material, but a magnetic material is preferably used.

The exchange coupling in the auxiliary recording layer including plural layers can be controlled by forming the exchange coupling-controlling layer. When an extremely thin non-magnetic layer is inserted between soft magnetic layers, that is, when the structure of a soft magnetic layer/a non-magnetic layer/a soft magnetic layer is selected, an indirect exchange coupling occurs between upper and lower soft magnetic layers. The indirect exchange coupling can be easily controlled by adjusting the thickness of the non-magnetic layer, and a number of repetitions of the structure of a soft magnetic layer/a non-magnetic layer/a soft magnetic layer.

In contrast, when the auxiliary recording layer has a structure such as a single soft magnetic layer, and two layers of a non-magnetic layer/a soft magnetic layer, the exchange coupling in the auxiliary recording layer cannot be controlled, because the exchange coupling varies depending on the kind of material constituting the soft magnetic layer. That is, when the auxiliary recording layer includes two layers, the non-magnetic layer is not inserted between the soft magnetic layers. Therefore, similarly to the auxiliary recording layer being a single layer, it is impossible to control the exchange coupling.

It is preferable that the non-magnetic layer constituting the auxiliary recording layer include at least one metal or one alloy of Ru, Ir, Rh, Re, Cu, Cr, Ta, W, and Ti, and more preferably at least one metal or one alloy of Ru, Ir, and Rh.

When the auxiliary recording layer includes plural non-magnetic layers, it is preferable that the thickness of each non-magnetic layer be in a range of from 0.2 nm to 2 nm. When the thickness is less than 0.2 nm, it is difficult to maintain uniformity over the entire non-magnetic layer. Due to this, a direct exchange coupling sometimes works between the upper and lower soft magnetic layers. In contrast, when it exceeds 2 nm, the distance between the upper and lower soft magnetic layers is too large, and an indirect exchange coupling may not work.

As a magnetic metal material of the soft magnetic layer, which constitutes the auxiliary recording layer, crystalline materials, such as Co, Ni, Fe, CoB, NiFe, and CoFe, can be used. In addition, amorphous materials which are obtained by adding Si, B, Al, Zr, Nb, C, etc. into the crystalline materials can also be used.

When the auxiliary recording layer contains plural soft magnetic layers, it is preferable that the thickness of each soft magnetic layer be 4 nm or less. When the thickness exceeds 4 nm, the main component of the residual magnetization is an in-plane direction, and thereby the signal intensity of the perpendicular magnetic recording medium may decrease.

In addition, when the auxiliary recording layer is a multiple layer, it is preferable that the total thickness of the soft magnetic layers be half or less the total thickness of the main recording layer. This is because when the total thickness of the soft magnetic layers exceeds half the total thickness of the main recording layer, the main component of the residual magnetization is an in-plane direction, and thereby the signal intensity of the perpendicular magnetic recording medium may decrease.

In general, these layers can be produced by a DC magnetron sputtering process or RF sputtering process. It is also possible to use an RF bias, a DC bias, a pulse DC, a pulse DC bias, O₂ gas, H₂O gas, and N₂ gas.

The sputtering gas pressure is determined in every layer so that each layer has optimum properties. However, the sputtering gas pressure is generally in a range of from about 0.1 to about 30 Pa. The sputtering pressure is determined depending on the performance desired in each layer.

Next, the protective layer 6 is explained.

The protective layer 6 protects the media from damage due to contact with the magnetic head. A SiO₂ film can be used as the protective layer 6. However, a carbon film is used in many cases. The film is formed by a sputtering process, a plasma CVD method, etc. The plasma CVD method has been used in many cases in recent years. A magnetron plasma CVD method is also possible. The thickness of the protective layer 6 is in a range of from 1 nm to 10 nm, preferably a range of from 2 nm to 6 nm, and more preferably a range of from 2 nm to 4 nm.

Next, the magnetic recording and reproducing device using the perpendicular magnetic recording medium is explained.

FIG. 4 shows one example of the magnetic recording and reproducing device using the perpendicular magnetic recording medium. The magnetic recording and reproducing device shown in FIG. 4 includes the magnetic recording medium 100 having the structure shown in FIG. 1, a medium driving portion 101 for rotary driving the magnetic recording medium 100, a magnetic head 102 for recording information to the magnetic recording medium 100 or reproducing information of the magnetic recording medium 100, a head driving portion 103 for moving the magnetic head 102 relatively to the magnetic recording medium 100, and a signal processing system 104 for recording and reproducing.

The signal processing system 104 processes data inputted from outside to produce a signal, and sends the signal to the magnetic head 102, or processes the signal reproduced by the magnetic head 102 to produce data, and sends the data outside.

As the magnetic head 102 used in the magnetic recording and reproducing device according to the present invention, any magnetic head which is suitable for high recording density, such as a magnetic head including not only a MR (Magneto Resistance) element which uses anisotropic magnetic resistance effects (AMR), but also a GMR element using giant magnetic resistance effects (GMR), a TuMR element using the tunnel effect, etc. can be used.

### EXAMPLES

Below, the present invention is explained in detail referring to examples.

### Example 1-1

A vacuum chamber, in which a glass substrate for a HD was set, was evacuated to 1.0×10⁻⁵ Pa or less in advance.

The soft magnetic backing layer 2 was produced on the substrate by layering CoNbZe having a thickness of 50 nm by the sputtering process. Next, the under layer 3 was produced by layering NiFe having an fcc structure in thickness of 5 nm in an Ar atmosphere having a gas pressure of 0.6 Pa. Then, the intermediate layer 4 was produced by layering Ru having a thickness of 10 nm in an Ar atmosphere having a gas pressure of 0.6 Pa, and further layering Ru having a thickness of 10 nm by increasing the gas pressure to 10 Pa.

The perpendicular magnetic recording medium 5 was produced by layering a main recording layer and an auxiliary recording layer in this order in an Ar atmosphere having a gas pressure of 2 Pa. The main recording layer was made of 90(Co12Cr18Pt)-10(SiO₂), and had a thickness of 10 nm.

Moreover, the numbers “90” and “10” in the chemical formula denote a molar ratio of Co12Cr18Pt, and SiO₂, respectively. The numbers “12” and “18” denote that Cr is contained at 12% by mol, and Pt is contained at 18% by mol. That is, “Co12Cr18Pt” means that it contains 12% by mol of Cr, 18% by mol of Pt, and residual 70% by mol of Co (this rule is used below).

The auxiliary recording layer was produced by alternately layering NiFe-10SiO₂ (thickness: 1.2 nm) and Ru-10SiO₂ (thickness: 0.6 nm) twice, and finally layering NiFe-8SiO₂ to a thickness of 1.2 nm.

Then, a carbon film was layered as the protective film 6, and a perfluoropolyether (PFPE) lubricant was coated to a thickness of 15 Å.

Thereby, the perpendicular magnetic recording medium of this example was produced.

### Example 1-2

The perpendicular magnetic recording medium in this example was produced in a manner identical to that of Example 1-1, except that Ir-10SiO₂ was used as the material of the non-magnetic layer in the auxiliary recording layer.

### Example 1-3

The perpendicular magnetic recording medium in this example was produced in a manner identical to that of Example 1-1, except that Rh-10SiO₂ was used as the material of the non-magnetic layer in the auxiliary recording layer.

### Comparative Example 1-1

A comparative perpendicular magnetic recording medium in this comparative example was produced in a manner identical to that of Example 1-1, except that the thickness of the main recording layer was 10 nm, and the auxiliary recording layer was not produced.

### Comparative Example 1-2

A comparative perpendicular magnetic recording medium in this comparative example was produced in a manner identical to that of Example 1-1, except that a simple layer made of NiFe-10SiO₂ having a thickness of 3.6 mm was used as the auxiliary recording layer.

### Comparative Example 1-3

A comparative perpendicular magnetic recording medium in this comparative example was produced in a manner identical to that of Example 1-1, except that a multiple layer, which was obtained by layering alternately a layer made of NiFe-10SiO₂ (thickness: 1.2 nm) and a layer made of Co-10SiO₂ (thickness: 0.6 nm) twice, and finally a layer made of NiFe-10SiO₂ (thickness: 1.2 nm), was used as the auxiliary recording layer. Moreover, a layer made of Co-10SiO₂ was a ferromagnetic layer.

Recording and reproducing properties of the produced perpendicular magnetic recording media were evaluated using a read-and-write analyzer 1632, and Spin Stand S1701MP, which are marketed by U.S. GUZIK Technical Enterprises.

As SNR of the medium, the value of the signal-noise ratio (SNR) (moreover, S is an output at the linear recording density of 119 kfci and N is a rms (root mean square)) of a differential waveform after passing a differentiation circuit value at a linear recording density of 716 kfci) was evaluated.

Medium overwrite properties were evaluated based on a reproduced output ratio (decrease ratio, OW) of 119 kfci signal before and after overwriting a 250 kfci signal to a 119 kfci signal.

As resistance to thermal fluctuation of the medium, a ratio of V₁₀₀₀/V₀ between the reproduced outputs of a 100 kfci signal after 1,000 seconds from recording a 100 kfci signal once at 70° C. and the reproduced outputs of a 100 kfci signal just after recording a 100 kfci signal once at 70° C.

Static magnetic properties in the perpendicular direction of the medium were evaluated by a Kerr measuring device.

The crystal structure and crystal orientation plane of the main recording layer and the auxiliary recording layer were confirmed by the θ-2θ method using an X-ray diffractometer using Cu-kα rays as a radiation source.

The fine structure of the main recording layer and the auxiliary recording layer was analyzed using a cross-sectional TEM. In addition, the average crystal grain diameter in the main recording layer and the auxiliary recording layer was calculated using planar TEM images.

As a result of the XRD evaluation, it was confirmed that magnetic crystal grains in the main recording layer of all perpendicular magnetic recording media have an hcp structure, and are orientated to the (0001) plane.

In addition, it was also confirmed that all auxiliary recording layers in the perpendicular magnetic recording medium produced in Example 1-1 and Comparative Examples 1-2 and 1-3 were orientated to the hcp (0001) plane or the fcc (111) plane.

As a result of the planar TEM observation, it was confirmed that the main recording layer in all perpendicular magnetic recording media had a granular structure in which the periphery of the magnetic crystal grains was surrounded by the boundary region. The average grain diameter of the magnetic crystal grains was 7.8 nm.

In addition, it was also confirmed that the auxiliary recording layer in the perpendicular magnetic recording medium in Example 1-1, and Comparative Examples 1-2 and 1-3 had a granular structure in which the periphery of the metal crystal grains was surrounded by the boundary region, similar to the main recording layer. The average grain diameter of the magnetic crystal grains was 7.5 nm.

As a result of the cross-sectional TEM observation, it was confirmed that one metal crystal grain in the auxiliary recording layer grew on one magnetic crystal grain in the main recording layer, and the metal crystal grain had a crystal lattice and grew epitaxially.

The coercive force Hc, and the squareness ratio RS, which were obtained by the static magnetic properties of the perpendicular magnetic recording medium, are shown in Table 1.

TABLE 1

| Sample | Hc (Oe) | RS |
|---|---|---|
| Example 1-1 | 3583 | 1.0 |
| Example 1-2 | 3622 | 1.0 |
| Example 1-3 | 3691 | 1.0 |
| Comparative Example 1-1 | 4673 | 1.0 |
| Comparative Example 1-2 | 3871 | 0.85 |
| Comparative Example 1-3 | 3248 | 0.78 |

Compared with the perpendicular magnetic recording medium in Comparative Example 1-1, Hc of the perpendicular magnetic recording medium in Examples 1-1 to 1-3, and Comparative Examples 1-2 and 1-3 decreases. In addition, RS in Examples 1-1 to 1-3 and Comparative Example 1-1 is 1, but RS in Comparative Examples 1-2 and 1-3 is deteriorated to less than 1. In the perpendicular magnetic recording medium in Comparative Example 1-3, since the auxiliary recording layer is a ferromagnetic film, properties are worse.

The overwrite properties OW, the SNR, and the resistance to thermal fluctuation V₁₀₀₀/V₀, which were obtained by the static magnetic properties of the perpendicular magnetic recording medium, are shown in Table 2.

TABLE 2

| Sample | OW (dB) | SNR (dB) | V₁₀₀₀/V₀ |
|---|---|---|---|
| Example 1-1 | 45.0 | 18.5 | 0.9996 |
| Example 1-2 | 43.8 | 18.3 | 0.9994 |
| Example 1-3 | 44.9 | 18.4 | 0.9993 |
| Comparative Example 1-1 | 36.7 | 17.0 | 0.9995 |
| Comparative Example 1-2 | 42.2 | 15.8 | 0.5920 |
| Comparative Example 1-3 | 45.3 | 15.2 | 0.5587 |

Compared with Comparative Example 1-1, OW in Example 1-1, and Comparative Examples 1-2, and 1-3 is improved. It can be presumed that this improvement is obtained by forming the auxiliary recording layer, and the coercive force is decreased.

In addition, the resistance to thermal fluctuation in Comparative Example 1-1 is substantially equal to that in Examples 1-1 to 1-3. However, the resistance to thermal fluctuation in Comparative Examples 1-2 and 1-3 is decreased. It can be presumed that this decrease of resistance to thermal fluctuation is caused by deterioration of the squareness ratio.

Regarding SNR, Example 1-1 displays the highest grade, and that of Examples 1-2 and 1-3 display the second highest grade. It can be presumed that such a high SNR is obtained by influences due to the RKKY interlayer coupling strength which is caused between NiFe-10SiO₂ layers.

Next, the perpendicular magnetic recording medium, in which the thickness of one soft magnetic layer in the auxiliary recording layer and the number of layers of the soft magnetic layer vary, were produced in the following manner.

### Example 2

After the intermediate layer was layered in the same manner as Example 1-1, a main recording layer was produced by layering 90(Co12Cr18Pt)-10(SiO₂) to a thickness of 10 nm. An auxiliary recording layer was produced by layering alternately NiFe-10SiO₂ (thickness: X nm) and Ru-10SiO₂ (thickness: 0.6 nm) at Y times, and finally NiFe-10SiO₂ to a thickness of X nm was layered.

Then, the protective layer was produced and the lubricant agent was coated on the protective layer, in the same manner as Example 1-1.

“X”, which is the thickness of NiFe-10SiO₂, was varied in a range of from 0 nm to 4 nm. “Y”, which is the layering time, was varied in a range of from 0 to 8. Moreover, the total thickness of the soft magnetic layers in the auxiliary recording layer was X×Y+X.

As a result of the XRD evaluation, it was confirmed that magnetic crystal grains in the main recording layer of all perpendicular magnetic recording media had an hcp structure, and orientated to the (0001) plane.

In addition, it was also confirmed that all auxiliary recording layers in the perpendicular magnetic recording media produced were orientated to the hcp (0001) plane or the fcc (111) plane.

As a result of the planar TEM observation, it was confirmed that the main recording layer in all perpendicular magnetic recording media had a granular structure in which the periphery of the magnetic crystal grains was surrounded by the boundary region. The average grain diameter of the magnetic crystal grains was 7.8 nm.

In addition, it was also confirmed that, similar to the main recording layer, the auxiliary recording layer in the perpendicular magnetic recording media had a granular structure in which the periphery of the metal crystal grains was surrounded by the boundary region. The average grain diameter of the magnetic crystal grains was 7.5 nm.

As a result of the cross-sectional TEM observation, it was confirmed that one metal crystal grain in the auxiliary recording layer grew on one magnetic crystal grain in the main recording layer, and the metal crystal grain had a crystal lattice and grew epitaxially.

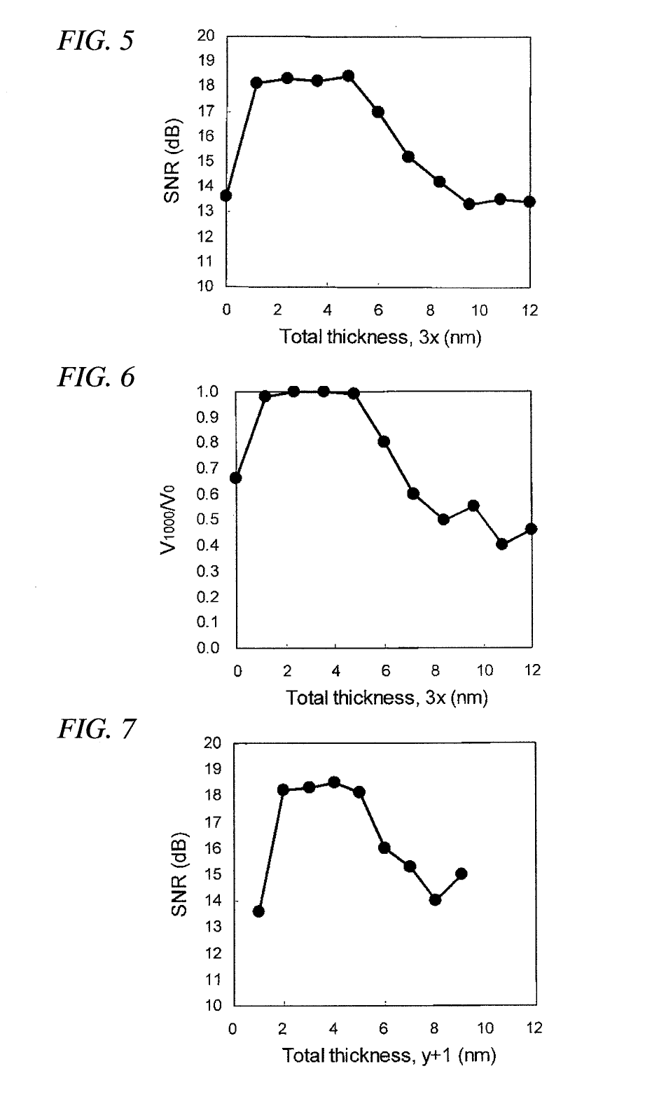

FIGS. 5 and 6 show the relationship between SNR or V₁₀₀₀/V₀, and the total thickness of the soft magnetic layer, 3X(=2×X+X), when the layering time, Y, of the soft magnetic layer in the auxiliary recording layer was set to 2, and the thickness, X, of one of the soft magnetic layer varied in a range of 0 nm to 4 nm.

It is clear that SNR is remarkably improved and high resistance to thermal fluctuation is maintained in a range of from 1.2 nm (X=0.4 nm) to 4.8 nm (X=1.6 nm) in the total thickness of the soft magnetic layers.

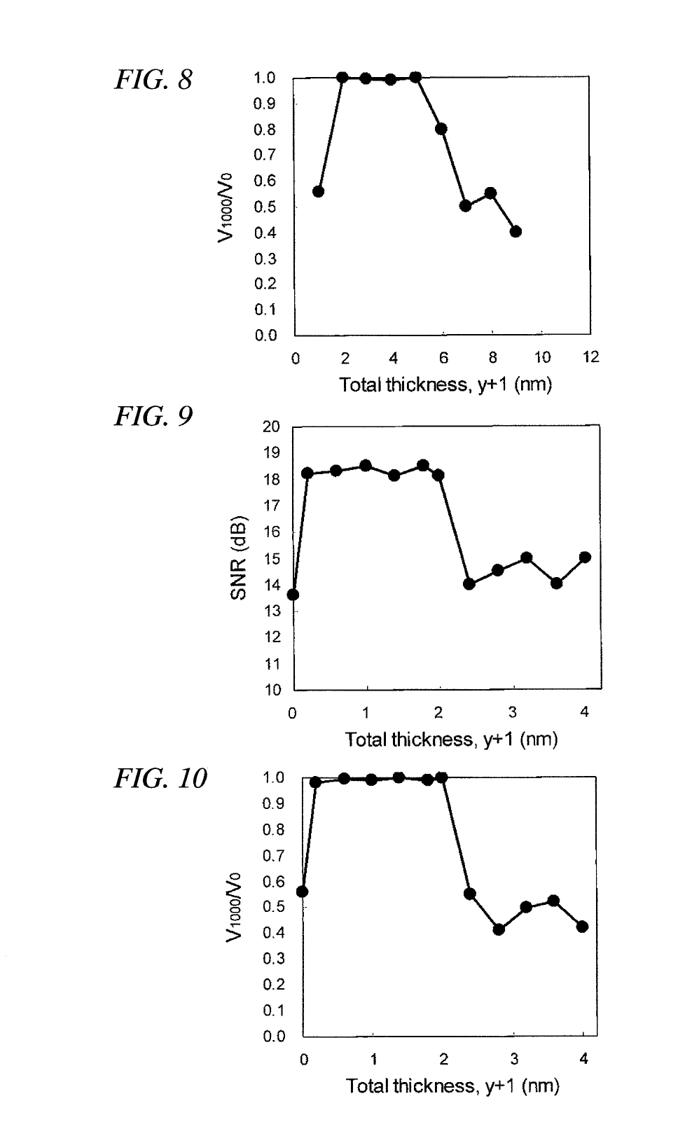

FIGS. 7 and 8 show the relationship between SNR or V₁₀₀₀/V₀, and the total thickness of the soft magnetic layer, Y+1(=Y×1+1), when the thickness, X, of one of the soft magnetic layer was set to 1 nm, and the layering time, Y, of the soft magnetic layer in the auxiliary recording layer was varied in a range of from 0 to 8.

It is clear that SNR is remarkably improved and high resistance to thermal fluctuation is maintained in a range of from 2 nm (Y=1) to 5 nm (Y=4) in the total thickness of the soft magnetic layers.

Based on these results, it is clear that when the total thickness of the soft magnetic layer in the auxiliary recording layer is half or less the thickness of the main recording layer, it is possible to obtain excellent recording and reproducing properties while maintaining high resistance to thermal fluctuation.

Then, the perpendicular magnetic recording media, in which the thickness of one non-magnetic layer in the auxiliary recording layer was varied, were produced in the following manner.

### Example 3

After the intermediate layer was layered in the same manner as Example 1-1, a main recording layer was produced by layering 90(Co12Cr18Pt)-10(SiO₂) to a thickness of 10 nm. An auxiliary recording layer was produced by alternately layering NiFe-10SiO₂ (thickness: 1.2 nm) and Ru-10SiO₂ (thickness: Z nm) twice, and finally NiFe-10SiO₂ to a thickness of 1.2 nm was layered.

Then, the protective layer was produced and the lubricant agent was coated on the protective layer, in the same manner as Example 1-1.

Moreover, the thickness, “Z”, of Ru-10SiO₂ was varied in a range of from 0 nm to 4 mn.

As a result of the XRD evaluation, it was confirmed that magnetic crystal grains in the main recording layer of all perpendicular magnetic recording media had an hcp structure, and were orientated to the (0001) plane.

In addition, it was also confirmed that all auxiliary recording layers in the perpendicular magnetic recording media produced were orientated to the hcp (0001) plane or the fcc (111) plane.

As a result of the planar TEM observation, it was confirmed that the main recording layer in all perpendicular magnetic recording media had a granular structure in which the periphery of the magnetic crystal grains was surrounded by the boundary region. The average grain diameter of the magnetic crystal grains was 7.8 nm.

In addition, it was also confirmed that, similar to the main recording layer, the auxiliary recording layer in perpendicular magnetic recording media had a granular structure in which the periphery of the metal crystal grains was surrounded by the boundary region. The average grain diameter of the magnetic crystal grains was 7.5 nm.

As a result of the cross-sectional TEM observation, it was confirmed that one metal crystal grain in the auxiliary recording layer grew on one magnetic crystal grain in the main recording layer, and the metal crystal grain had a crystal lattice and grew epitaxially.

FIGS. 9 and 10 show the relationship between SNR or V₁₀₀₀/V₀, and the thickness of one non-magnetic layer, Z, when the thickness of one non-magnetic layer Z in the auxiliary recording layer was varied in a range of from 0 to 4 nm.

It is clear that SNR is remarkably improved and high resistance to thermal fluctuation is maintained when Z is in a range of from 0.2 nm to 2 nm. When Z exceeds 2 nm, both SNR and V₁₀₀₀/V₀ decrease. It can be presumed that the decrease of SNR and V₁₀₀₀/V₀ is caused because the distance between the soft magnetic layers in the auxiliary recording layer is too large, and RKKY interlayer coupling does not work.

Based on these results, it is clear that when the thickness of the non-magnetic layer in the auxiliary recording layer is in a range of from 0.2 mm to 2 nm, it is possible to obtain excellent recording and reproducing properties while maintaining resistance to thermal fluctuation.

Next, the perpendicular magnetic recording media, in which the composition and the kind of the oxides contained in the main recording layer and the auxiliary recording layer were varied, were produced in the following manner.

### Example 4

After the intermediate layer was layered in the same manner as Example 1-1, a main recording layer was produced by layering 90(Co12Cr18Pt)-a(SiO₂) to a thickness of 10 nm. An auxiliary recording layer was produced by layering alternately NiFe-bSiO₂ (thickness: 1.2 nm) and Ru-bSiO₂ (thickness: 0.6 nm) twice, and finally NiFe-bSiO₂ to a thickness of 1.2 nm was layered.

Then, the protective layer was produced and the lubricant agent was coated on the protective layer, in the same manner as Example 1-1.

Moreover, the content “a” of the oxide in the main recording layer, and the content “b” of the oxide in the auxiliary recording layer were varied in a range of from 0% by mol to 30% by mol. In addition, the perpendicular magnetic recording media, in which TiO, TiO₂, WO₃, and Cr₂O₃ were used as the grain region material in the main recording layer and the auxiliary recording layer, instead of SiO₂, were also prepared.

As a result of the XRD evaluation, it was confirmed that magnetic crystal grains in the main recording layer of all perpendicular magnetic recording media had an hcp structure, and were orientated to the (0001) plane.

In addition, it was also confirmed that all auxiliary recording layers in the perpendicular magnetic recording media produced were orientated to the hcp (0001) plane or the fcc (111) plane.

As a result of the planar TEM observation, it was confirmed that the main recording layer, in which a is 2 or more, had a granular structure in which the periphery of the magnetic crystal grains was surrounded by the boundary region.

In addition, it was also confirmed that the auxiliary recording layer, in which b is 2 or more, had a granular structure in which the periphery of the metal crystal grains are surrounded by the boundary region.

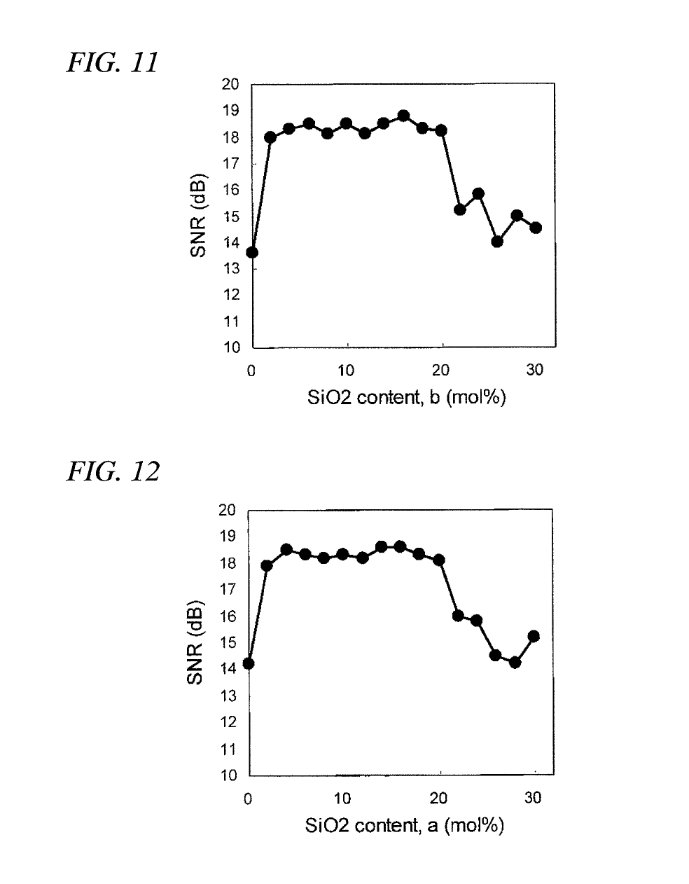

FIG. 11 shows the relationship between b and SNR, when the content, a, of SiO₂ in the main recording layer was set to 10, and the content, b, of SiO₂ in the auxiliary recording layer was varied in a range of from 0 to 30.

It is clear that SNR is remarkably improved when the content of SiO₂ is in a range of from 1% by mol to 20% by mol. Similar to SiO₂, the remarkable improvement of SNR was obtained in the perpendicular magnetic recording medium using TiO, TiO₂, and Cr₂O₃.

FIG. 12 shows the relationship between a and SNR, when the content, b, of SiO₂ in the auxiliary recording layer was set to 10, and the content, a, of SiO₂ in the main recording layer was varied in a range of from 0 to 30.

It is clear that SNR is remarkably improved when the content of SiO₂ is in a range of from 2% by mol to 20% by mol. Similar to SiO₂, the remarkable improvement of SNR was obtained in the perpendicular magnetic recording medium using TiO, TiO₂, and Cr₂O₃.

Based on these results, it is clear that when the content of the oxides in the auxiliary recording layer and the main recording layer is in a range of from 2% by mol to 20% by mol, it is possible to obtain excellent recording and reproducing properties while maintaining high resistance to thermal fluctuation.

### INDUSTRIAL APPLICABILITY

According to the present invention, it is possible to provide a perpendicular magnetic recording medium which can maintain high thermal stability of the perpendicular magnetic recording layer, and has excellent recording and reproducing properties, and high recording density.

1. A perpendicular magnetic recording medium including at least a soft magnetic backing layer, an under layer, an intermediate layer, and a perpendicular magnetic recording layer, which are disposed on a non-magnetic substrate,
wherein the perpendicular magnetic recording layer includes at least one of a main recording layer and at least one of an auxiliary recording layer,
the main recording layer includes a layer having perpendicular magnetic anisotropy,
the auxiliary recording layer is a multilayer including three or more of a soft magnetic layer and a non-magnetic layer which are layered alternately, and the outermost layer to the non-magnetic substrate is the soft magnetic layer.

2. A perpendicular magnetic recording medium according to claim 1, wherein the thickness of each non-magnetic layer constituting the auxiliary layer is in a range of from 0.2 nm to 3 nm.

3. A perpendicular magnetic recording medium according to claim 1, wherein the non-magnetic layer constituting the auxiliary layer contains at least one metal or an alloy of Ru, Ir, Rh, Re, Cr, Cu, Ta, W and Ti.

4. A perpendicular magnetic recording medium according to claim 1, wherein the thickness of the soft magnetic layer constituting the auxiliary layer is 4 nm or less, and the total thickness of the soft magnetic layer constituting the auxiliary recording layer is half or less the total thickness of the main recording layer.

5. A perpendicular magnetic recording medium according to claim 1, wherein the non-magnetic layer and the soft magnetic layer, which constitute the auxiliary recording layer, have a granular structure in which a metal crystal grain part is surrounded by a non-magnetic oxide grain boundary, and the oxide contains at least one of Si, Ti, Ta, Cr, Al, W, Nb, Mg, Ru, and Y.

6. A perpendicular magnetic recording medium according to claim 1, wherein the total amount of the oxide contained in the auxiliary recording layer is in a range of from 2% by mol to 20% by mol.

7. A perpendicular magnetic recording medium according to claim 1, wherein at least one layer of the main recording layer has a granular structure in which a magnetic crystal grain part is surrounded by a non-magnetic oxide grain boundary, and the oxide contained in the main recording layer contains at least one of Si, Ti, Ta, Cr, Al, W, Nb, Mg, Ru, and Y.

8. A perpendicular magnetic recording medium according to claim 1, wherein the total amount of the oxide contained in the main recording layer is in a range of from 2% by mol to 20% by mol.

9. A perpendicular magnetic recording medium according to claim 1, wherein the average diameter of the magnetic crystal grains in the main recording layer is in a range of from 3 nm to 12 nm.

10. A perpendicular magnetic recording medium according to claim 1, wherein the thickness of the main recording layer is in a range of from 1 nm to 20 nm, and the total thickness of the perpendicular magnetic recording layer including the main recording layer is in a range of from 2 nm to 40 nm.

11. A perpendicular magnetic recording medium according to claim 1, wherein the soft magnetic backing layer has a soft magnetic non-crystalline structure or a soft magnetic fine crystalline structure.

12. A perpendicular magnetic recording and reproducing device having a perpendicular magnetic recording medium and a magnetic head for recording and reproducing information of a perpendicular magnetic recording medium, wherein the perpendicular magnetic recording medium is the perpendicular magnetic recording medium according to claim 1.
